(19) United States
(12) Patent Application Publication
(10) Pub. No.: US 2018/0023006 A1
(43) Pub. Date: Jan. 25, 2018

(54) Oil recovery from sediments and residues from oil field operations

(71) Applicants: Felipe Lembcke, Keller, TX (US); Eduardo Gomez Maqueo, Keller, TX (US)

(72) Inventors: Felipe Lembcke, Keller, TX (US); Eduardo Gomez Maqueo, Keller, TX (US)

(21) Appl. No.: 15/215,146

(22) Filed: Jul. 20, 2016

(51) Int. Cl. C10G 1/04; B01D 3/40; B01D 71/02; B01D 21/24; B01D 11/04; B01D 17/02

(52) U.S. Cl. CPC C10G 1/045; B01D 11/0446; B01D 17/0214; B01D 71/025; B01D 21/245; B01D 21/2488; B01D 11/0415; B01D 3/40; B01D 2325/02; C10G 2300/80

(57) ABSTRACT

The inventors have invented a method to recover oil from sediments and residues from the oil field operations, comprising a series of water, solids and solvent contacting units to separate the silt and solids from the hydrocarbon phase into the water phase and a ceramic membrane filtration system for the recovery of the solvent.

### FIELD OF THE INVENTION

This invention relates to an enhanced method and system for the removal of silt from residues generated in oil field operations and the extraction of the hydrocarbon phase present in them.

### BACKGROUND

In oil field operations, large volumes of solid waste is generated from well perforation, flowback with solids (sand and silt), and other solids with hydrocarbons, which end up in waste disposal facilities.

In order to recover some valuable hydrocarbons from these wastes, the typical operation in these sites is to deposit all the residues together in large lined open pits. Once the pit is full to a certain level, water is introduced to allow the hydrocarbon phase to be leached out, forming an additional phase on top of the aqueous phase. The hydrocarbon layer is scraped off and collected to be sold. Large solids remain in the solid phase along with some hydrocarbons, and the hydrocarbon phase has some amount of silt in the form of clays and other fine particles. The water used, if recovered, is sent to an emulsion breaker process to recover the emulsified oil present.

For the purpose of this application, silt is defined as small solid particles which pass through a 200 mesh screen, and may include for example, clays, fine sands and other small size solid particles.

### SUMMARY OF THE INVENTION

In order to speed up the process and to remove the silt, several procedures have been proposed based on using water and a solvent to allow the entrapped silt to be separated from the hydrocarbon layer and these fine solids to be captured by the water layer, producing a cleaner hydrocarbon phase for sale.

By reducing the salt and silt content of the oil, substantial savings can be obtained by the refineries, so a larger premium is paid for these recovered hydrocarbons.

Simple washing of the oily waste with water separates the larger particles of solids from the mixture, and silt covered with hydrocarbons is distributed between the water and hydrocarbon phases, producing a low quality oil product. The silt removed in the water phase retains a considerable amount of hydrocarbons which are desired to be recovered, and the oil phase retains a considerable amount of silt which is desired to be removed.

The use of an appropriate solvent to allow the hydrocarbon covering the silt to be detached from its surface is proposed in the present patent. A petroleum distillate will help the hydrocarbon phase to be detached from the silt surface. The selected hydrocarbon distillate should not contain too much high boiling point hydrocarbons, since they tend to form emulsions with water, which may hinder their solvency efficiency. The use of solvent will also reduce the viscosity of the hydrocarbon phase and allow it to flow more easily. The solvent will dissolve the low to medium molecular weight hydrocarbons present, and a separation process based on ceramic membrane filtration is presented to recover such solvent.

Even though a hydrocarbon recovered stream including silt may be used in refining processes, the presence of such silt will decrease the life expectancy of the refining process and may hinder the efficiency of the system. Therefore, a pre-treatment process is usually in place in the refineries to maximize the efficiency and process life of their equipment.

The main objective of the present invention is to provide a process for the effective recovery of the hydrocarbon phase present in sediments and residues generated by oil field operations.

### BRIEF DESCRIPTION OF THE DRAWINGS

FIG. 1 shows a process diagram for one embodiment of the invention.

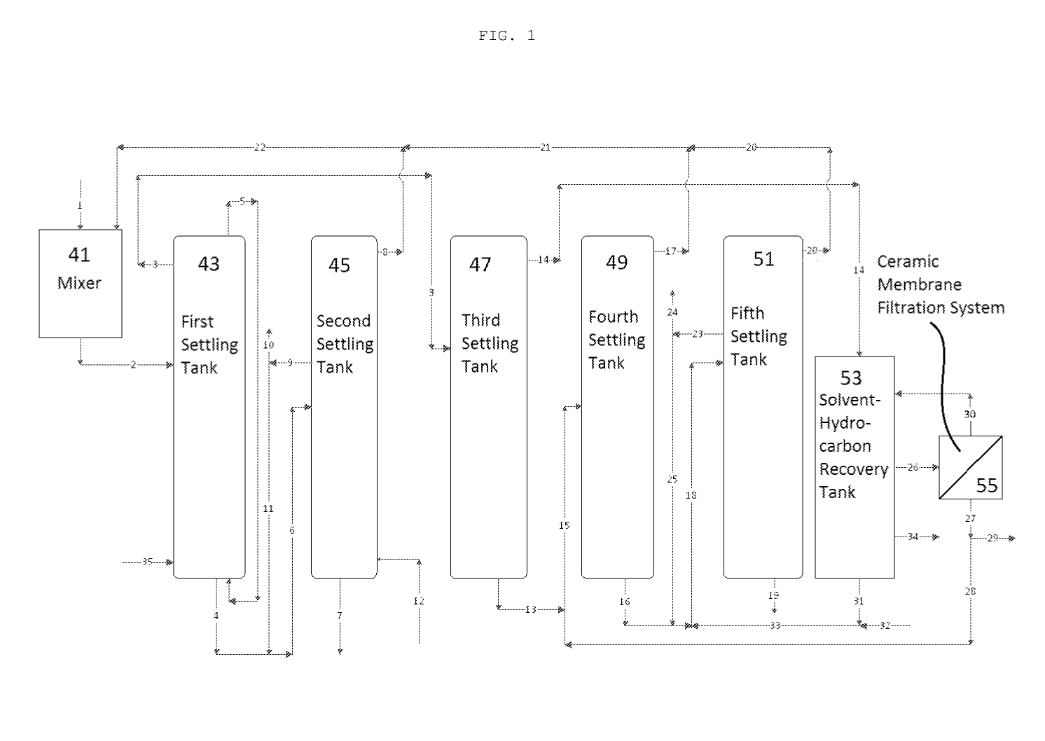

### DETAILED DESCRIPTION OF THE INVENTION

According to the preferred embodiment of the present invention, a Raw Stream 1 of oil field operations waste containing hydrocarbons, water, silt and solids is fed to Mixer 41, along with a solvent-rich Stream 22 coming from units downstream, to start the separation of the different phases present.

The Mixed Stream 2 of solids, silt, hydrocarbons and solvent exits Mixer 41 and is fed into First Settling Unit 43. As the solvent starts acting over the solution, a Top Solvent Stream 5 with dissolved hydrocarbons is taken from the top of the First Settling Tank 43 and recirculated to the bottom of the First Settling Tank 43 in order to help fluidize the bed within it and increase the separation.

Current embodiments of the invention use flow velocities from 2 to 10 ft/sec, based on the viscosity of the hydrocarbon phase and the amount of solids present; the flow is necessarily slower with more solids and less viscous fluid.

After a period of time, a Solids Phase Flow 4 leaves from the bottom of the First Settling Tank 43, after which it mixes with Stream 11 to create Stream 6 and enters Second Settling Tank 45, along with Settling Water 12, which removes the remaining attached hydrocarbons and solvents from the large particle size solids remaining in the process fluid.

The addition of the Settling Water 12 allows the formation of a light solvent-hydrocarbon layer on the top of the processing fluid in the Second Settling Tank 45; the solvent-hydrocarbon layer is an intermediate aqueous phase with some silt included.

The process fluid containing larger particle size solids phase at the bottom of the Second Settling Tank 45, from where it is discharged practically clean of hydrocarbons as Disposal Stream 7.

The aqueous phase is removed from the middle section of Second Settling Tank 45 as Stream 9, which is split into a Stream 10 which is sent to an emulsion breaking process outside the scope of this system and Stream 11, which is mixed with Solids Phase Flow 4 coming from First Settling Tank 43 to produce Stream 6 and fed into the Second Settling Tank 45. The Solvent Phase 8 leaves from the top of the exits from the top of Second Settling Tank 45, mixes with Stream 21 coming from units downstream to produce Stream 22 and is sent back to the Mixer 41 to start the extraction of hydrocarbons.

The solvent and hydrocarbon phase from the First Settling Tank 43 is extracted from the top into Stream 3 and transferred to a Third Settling Tank 47, where phase separation occurs. The top layer is rich in solvent and hydrocarbons, essentially silt-free, and it is removed from the top of the unit into Stream 14 and sent to a Solvent-Hydrocarbon Recovery Tank 53 which will be used to feed the Solvent Recovery Unit 55.

The lower portion of the process fluid in the Third Settling Tank 47 includes water and silt, and is removed from the unit's bottom as Stream 13 and sent to a Fourth Settling Tank 49, mixing with freshly recovered solvent from Stream 28 to produce Stream 15, which is fed to the Fourth Settling Tank 49 to be able to further remove the hydrocarbons from silt, and allowed to settle into separate phases. During this process, a solvent-hydrocarbon rich layer is formed at the top of the Fourth Settling Tank 49, and extracted into Stream 17, where it is mixed with Stream 20 from units downstream to produce Stream 21, which is recirculated to Mixer 41. An intermediate water-silt layer forms in the middle to bottom section of the Fourth Settling Tank 49 and exits into Stream 16 to be transferred to Fifth Settling Tank 51.

Before entering Fifth Settling Tank 51, the water-silt Stream 6 is mixed with more water coming from Stream 25 coming from Fifth Settling Tank 51 and Stream 33 coming from the Solvent-Hydrocarbon Recovery Tank 53, to further clean the silt.

Inside Fifth Settling Tank 51, a top layer rich in solvent and hydrocarbons detached from the silt is extracted from its top into Stream 20 and sent back to the Mixer 41 to help with the separation. Stream 20 is mixed with Stream 17 from Fourth Settling Tank 49 to produce Stream 21 and sent back to Mixer 41. An intermediate layer of water is formed which is extracted in Stream 23, purging excess water into Stream 24 and sent to a water recovery system. The remainder water from Stream 23 continues on Stream 25 and mixes with Stream 6 coming from s Fourth Settling Tank 49. And finally, a silt-rich layer, essentially free of hydrocarbons is discharged from the bottom into Stream 19 and sent to waste disposal.

The solvent recovery system is essential to the economic feasibility of the process. In the preferred embodiment, a Ceramic Membrane Filtration System (CMFS) 55 is used for this purpose. The Solvent-Hydrocarbon Recovery Tank 53 feeds the Ceramic Membrane Filtration System 55, which contains solvent and hydrocarbons essentially free of silt.

Some water may be present in the Solvent-Hydrocarbon Recovery Tank 53 carried out by the process. If such is the case, water is allowed to settle to the bottom of the Solvent-Hydrocarbon Recovery Tank 53, a hydrocarbon rich layer deposits on top of the aqueous layer, and a solvent-rich layer is formed at the very top of the Solvent-Hydrocarbon Recovery Tank 53. From this top layer, a Stream 26 is fed to the Ceramic Membrane Filtration System 53 to concentrate the large-chain hydrocarbons by permeating the lighter components present in Stream 26.

A solvent-rich Stream 27 leaves the Ceramic Membrane Filtration System 55 and used for the extraction process. Stream 27 is divided into Stream 29 which recovers the excess solvent produced in the extraction process, and Stream 28 which is sent back to mix with Stream 13 from Fourth Settling Tank 49 to produce Stream 15 to be fed into Fifth Settler Tank 51.

The concentrate from the Ceramic Membrane Filtration System 55 is sent back to the Solvent-Hydrocarbon Recovery Tank 53 and allowed to settle. Water is extracted from the bottom of the Solvent-Hydrocarbon Recovery Tank 53 into Stream 31 to be mixed with a fresh Water Stream 32 to produce Stream 33 which is sent back to Fifth Settler Tank 51 after mixing with Streams 25 and 16. The hydrocarbon rich layer is extracted from the middle section of the Ceramic Membrane Filtration System 55 into Stream 34 and transferred to transport tanks for sale.

For all separators included in the described process, the equipment of pressure release valves allows for the removal of gases generated in the process, which in turn can be used to fluidize the solids-hydrocarbon-solvent mixture in the First Settling Tank 43 in Stream 35. Gases such as carbon dioxide or nitrogen may be used to help the fluidization process, but due to the nature of the solvent, air or oxygen are to be avoided inside the units to prevent any explosive environment.

### EXAMPLE

Waste sludge from a waste disposal site in south Texas was fed to the process, along with a petroleum distillate solvent with a boiling point range between 140° F. and 300° F. The apparent composition by weight of the sludge is 35% solids, 30% hydrocarbons, and the water as the remainder. The solvent is fed to the unit in a proportion of 3 parts to 1 part of sludge. (Several feed ratios were experimented but only the results from the mentioned one are presented here.) The amount of solvent depends on the density and viscosity of the waste stream to be treated. In this case, since the hydrocarbon phase has a gravity around 30° API, a 3:1 ratio of solvent to sludge was used, resulting in 95% of the hydrocarbons present in the sludge recovered in a stream with less than 1% silt. The solvent was able to be reused in the process even though it increased its density by 10%, and it still retained its solvency.

In this example, the recovered hydrocarbon phase ended up around 36° API. The ceramic membrane elements used in the process were alumina-based, with pore size of 100 nm, 19 channels and 6 mm channel diameter for a 0.358 m2 surface area per element.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

A legend of the drawing and elements of the invention:

| | |
|---|---|
| Raw Stream 1 | Settling Water 12 |
| Mixed Stream 2 | Water Stream 32 |
| Solids Phase Flow 4 | Stream 33 |
| Top Solvent Stream 5 | Stream 35 |
| Disposal Stream 7 | Mixer 41 |
| First Settling Tank 43 | |
| Second Settling Tank 45 | |
| Third Settling Tank 47 | |
| Fourth Settling Tank 49 | |
| Fifth Settler Tank 51 | |
| Solvent-Hydrocarbon Recovery Tank 53 | |
| Ceramic Membrane Filtration System 55 | |

The inventors claim:

1. A method for the recovery of oil from sediments and residues from the oil field operations which comprises of a series of water, solids and solvent-contacting units to separate the silt and solids from the hydrocarbon phase into the water phase and a ceramic membrane filtration system for the recovery of the solvent.

2. A method for the recovery of oil from cuttings of oil perforation processes which comprises:
a. mixing a hydrocarbon-solid sludge mixture with a solvent to detach any hydrocarbon phase within the sludge mixture from any solid phase in a mixing unit;
b. sending the resulting mixture to a first separator settler unit where any existing solids-rich phase settles to the bottom of the unit, any solvent-rich hydrocarbon phase is recovered at the top of the unit and a partial stream of said solvent-rich hydrocarbon phase is recirculated to the bottom of the unit to help fluidize the sludge;
c. recovering the solids-rich layer from the first separator settler and sending it to a second separator settler and adding water to clean the recovered solids-rich layer and recovering an additional solvent hydrocarbon layer for recirculation to the first separator settler unit, and disposing any practically clean solids resulting from the process from the bottom of the first separator settler unit;
d. sending the rest of the solvent-rich stream from the first separator settler unit to a second separator settler unit for further solvent and hydrocarbons recovery, allowing any existing silt rich layer to settle to the bottom of the second separator settler unit;
e. sending any existing solvent-rich layer in the top of the second separator settler unit with any recovered hydrocarbons to a solvent-recovery tank and sending any silt-rich layer in the lower part of the second separator settler unit to a third separator settler unit;
f. injecting any recovered solvent into the third separator settler unit to allow the detachment of any hydrocarbons covering the surface of the silt,
g. recovering any solvent-rich layer at the top of the third separator settler unit and sending it back to the first separator settler unit to initiate a hydrocarbon phase recovery;
h. recovering any rich-silt layer from the bottom of the third separator settler unit, and sending it to a washer unit;
i. injecting water into the washing unit to complete the removal of the hydrocarbon phase from the silt surface,
j. recirculating any solvent-rich layer that forms at the top of the third separator settler unit to the first separator settler,
k. sending any middle water rich layer forming in the middle of the third separator settler unit to an emulsion-breaking system;
l. disposing of any clean silt layer at the bottom which is sent to a disposal site,
m. recovering solvent in the solvent-recovery tank with a ceramic membrane filtration system, wherein the solvent-rich layer forms at the top of the tank, any hydrocarbon layer forms at the middle of the tank and removed for transport, and water settles to the bottom of the tank and then extracted to the emulsion breaking system, and any solvent-rich layer is fed to the ceramic membrane filtration system where solvent is recovered in the permeate side and then sent back into the process to continue the extraction process,
n. concentrating hydrocarbons in the concentrate side of the unit and then sending it back to the solvent recovery tank and allowing it to settle and exit with the recovered hydrocarbon layer for transport.

3. The system set forth in claim 2, where the feed includes cuttings from oil perforation operations.

4. The system set forth in claim 2, where the feed includes flowback or frac water with solids.

5. The system set forth in claim 2, where the ceramic membrane filtration system for the solvent recovery includes ceramic membrane elements with diameter between 25 mm and 40 mm, pore size ranging from 50 nm to 1400 nm, between 1 to 61 channels and channel diameter between 1 to 30 mm constructed of alumina and including a mixture of one or more of magnesia, silica, zirconia, or titania in their construction formulation.

6. The system set forth in claim 2, where the solvent used is of petroleum distillation process origin with boiling point range between 140° F. and 300° F.

7. The system set forth in claim 2, where a non-oxidizing gas like carbon dioxide, nitrogen or gas evolved from the process mixture is used to help fluidize the hydrocarbon-water-solvent mixture in the second separator settler unit.
